(19) United States
(12) Patent Application Publication
(10) Pub. No.: US 2007/0103051 A1
(43) Pub. Date: May 10, 2007

(54) IMAGE DISPLAY APPARATUS

(76) Inventors: Hirotaka Unno, Fukaya-shi (JP); Akiyoshi Yamada, Fukaya-shi (JP); Tsukasa Ooshima, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/608,255

(22) Filed: Dec. 8, 2006

Related U.S. Application Data
(63) Continuation of application No. PCT/JP05/10179, filed on Jun. 2, 2005.

(30) Foreign Application Priority Data
Jun. 8, 2004 (JP) 2004-170039

(51) Int. Cl. H01J 1/62

(52) U.S. Cl. 313/495

(57) ABSTRACT

A vacuum envelope of an image display apparatus includes a front substrate and rear substrate opposing each other with a gap defined therebetween, and a frame provided between peripheral edges of the front substrate and rear substrate and attached in a sealed state to the front and rear substrates by a sealing material. The frame is formed by bonding a plurality of frame members, and includes at least two joints.

### CROSS-REFERENCE TO RELATED APPLICATIONS

This is a Continuation Application of PCT Application No. PCT/JP2005/010179, filed Jun. 2, 2005, which was published under PCT Article 21(2) in Japanese.

This application is based upon and claims the benefit of priority from prior Japanese Patent Application No. 2004-170039, filed Jun. 8, 2004, the entire contents of which are incorporated herein by reference.

### BACKGROUND OF THE INVENTION

1. Field of the Invention

This present invention relates to a flat shaped image display apparatus including a pair of substrates which are opposed to each other and a frame member arranged between the substrates.

2. Description of the Related Art

In recent years, various image display devices have been developed as next-generation light-weight, small-thickness display devices, which will take the place of cathode-ray tubes (hereinafter, referred to as CRTs). Such image display devices include liquid crystal displays (LCDs) which control the intensity of light by making use of alignment of liquid crystal, plasma display panels (PDPs) which cause phosphors to emit light by ultraviolet of plasma discharge, field emission displays (FEDs) which cause phosphors to emit light by electron beams of field-emission-type electron emitting elements, and further, as one of the FED, a flat display device surface-conduction electron-emitter displays (SEDs) which cause phosphors to emit light by electron beams of surface-conduction-type electron emitting elements.

The FED, for example, generally comprises a front substrate and a rear substrate that are opposed to each other across a predetermined gap. These substrates have their respective peripheral portions joined together by a rectangular frame, thereby forming a vacuum envelope. A phosphor screen is formed on the inner surface of the front substrate. Provided on the inner surface of the rear substrate are a large number of electron emitting elements for use as electron emission sources, which excite the phosphors to luminescence.

A plurality of support members are provided between the rear substrate and the front substrate in order to support an atmospheric-pressure load acting on these substrates. The rear substrate-side potential is substantially set at a ground potential, and an anode voltage is applied to the phosphor surface. Electron beams, which are emitted from a number of the electron emitting elements, are applied to red, green and blue phosphors of the phosphor screen, and cause the phosphors to emit light. Thereby, an image is displayed.

According to the display apparatus constructed in this manner, the thickness of the display device can be reduced to about several millimeters, so that the device can be made lighter in weight and thinner than CRTs that are used as displays of existing TVs or computers.

In the above-described FED, it is necessary to maintain the interior of the envelope in a high vacuum state. Jpn. Pat. Appln. KOKAI Publication No. 2001-229825, for example, has proposed a method, as means for evacuating an envelope, for performing, in a vacuum vessel, final assembly of a front substrate and rear substrate that form the envelope. In this method, a low-melting-point metal material, such as In, suitable for a simultaneous process of attaching and sealing, is used as a sealing material. The method enables the attaching/sealing process and vacuum-sealing process to be performed simultaneously. Further, it does not require such a long process time as the time required when the envelope is exhausted using an exhaust pipe. Among other advantages, it can provide an extremely high degree of vacuum.

However, the frame of glass is expensive, and the method includes a process for bonding the frame to one of the substrates in the atmosphere. Therefore, the method involves a high manufacturing cost. As means for overcoming the problem, Jpn. Pat. Appln. KOKAI Publication No. 2003-068238, for example, has proposed a method for performing, in a vacuum atmosphere, bonding of substrates to a metal frame. In this method, current is passed through In to melt it for adhesion.

When the substrates and frame are joined in a sealed state in a vacuum, if the frame is deformed even only a little, molten In moves along the deformed frame during baking in a vacuum, with the result that variations may well occur in the height or thickness of In. If, in this state, current is passed through the frame to execute heating adhesion, In cannot simultaneously be melted over the entire region. Accordingly, a long time is required to melt In over the entire region, which inevitably results in a reduction in mass productivity. Further, local heating of In may occur. In this case, the wettability of In may be degraded because of excessive local heat generation, whereby atmospheric ingress due to defective adhesion, or breakage of the substrates due to an increase in thermal deformation stress may occur.

When in the adhesion process, the frame is put in a vacuum, the frame pressed by the upper and lower substrates via In of a solid state assumes a free state after the solid In is melted by heating due to power distribution. In this state, movement of In occurs as in the above case, and hence the same problem as the above occurs. To avoid this, a technique for highly accurately processing the frame for a large display in accordance with the adhesion position is necessary. Since frames are thin and are not so rigid, even a frame as designed cannot be easily handled, and may well be deformed during transfer to a vacuum vessel for substrate adhesion.

### BRIEF SUMMARY OF THE INVENTION

The present invention has been developed in light of the above, and aims to provide a flat image display apparatus of high airtightness suitable for mass production.

In order to achieve the object, there is provided an image display apparatus which comprises a front substrate and a rear substrate opposing each other with a gap defined therebetween; and a frame arranged between peripheral edges of the front and rear substrates and attached in a sealed state to the front and rear substrates by a sealing material, the frame being formed by bonding a plurality of frame members, and includes at least two joints.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a partly broken perspective view illustrating an FED according to an embodiment of the invention;

FIG. 2 is a sectional view taken along line II-II;

FIG. 3 is a plan view illustrating the phosphor screen of the FED;

FIG. 4 is a plan view illustrating the front substrate and frame of the FED;

FIG. 5 is a sectional view illustrating a state in which a rear substrate and the front substrate with the frame are opposed to each other immediately before they are put into a vacuum apparatus;

FIG. 6 is a view schematically illustrating a vacuum processing apparatus used for producing the FED;

FIG. 7 is a plan view illustrating the front substrate and frame of an FED according to a first modification of the invention;

FIG. 8 is a plan view illustrating the front substrate and frame of an FED according to a second modification of the invention;

FIG. 9 is a plan view illustrating the front substrate and frame of an FED according to third modification of the invention; and

FIG. 10 is a plan view illustrating the front substrate and frame of an FED according to a fourth modification of the invention.

### DETAILED DESCRIPTION OF THE INVENTION

An FED as an image display apparatus according to an embodiment of the invention will be described in detail with reference to the accompanying drawings.

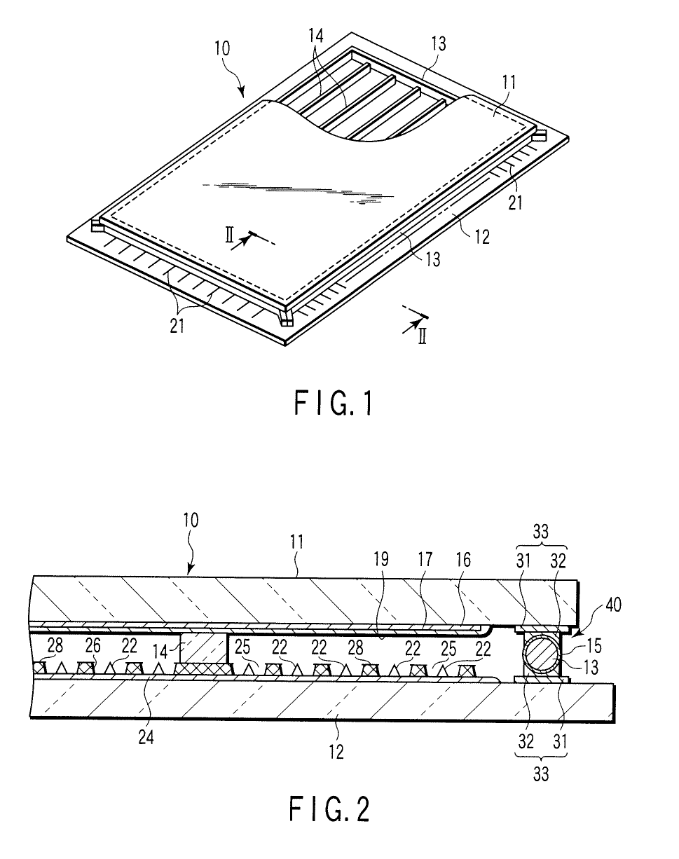

As shown in FIGS. 1 and 2, the FED comprises, as insulated substrates, a front substrate 11 and rear substrate 12 that are formed of rectangular glass and oppose each other with a gap of about 1.5 to 3.0 mm therebetween. The front substrate 11 and rear substrate 12 have their peripheral edges bonded to each other by a rectangular frame 13 functioning as a side wall, thereby providing a flat, rectangular vacuum envelope 10 having its interior maintained in a vacuum state.

The vacuum envelope 10 contains a plurality of plate-shaped support members 14 for supporting the atmospheric pressure applied to the front and rear substrates 11 and 12. The support members 14 extend in the direction parallel to the long side of the vacuum envelope 10, and are arranged at regular intervals in the direction parallel to the short side. The shape of the support members 14 is not limited to this. They may be columnar members.

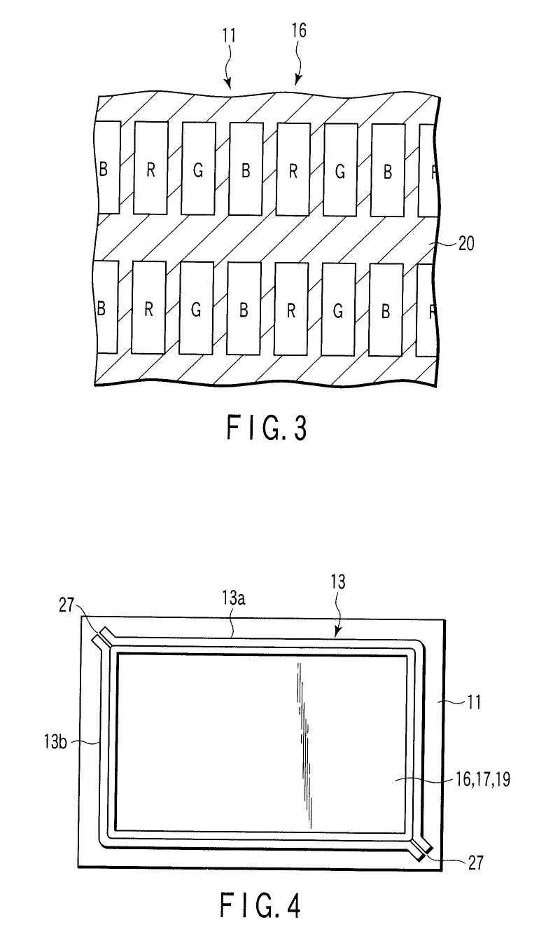

As shown in FIGS. 2 and 3, a phosphor screen 16 is formed on the inner surface of the front substrate 11. The phosphor screen 16 includes rectangular phosphor layers R, G and B that are luminous in red, blue and green, respectively, and are arranged in a matrix, and a light shielding layer 20 provided between the phosphor layers. A metal back 17 of aluminum, for example, and getter film 19 are stacked in this order on the phosphor screen 16.

A large number of electric-field emission type electron emission elements 22, which emit respective electron beams, are provided on the inner surface of the rear substrate 12 as electron emission sources for activating the phosphor layers R, G and B. The electron emission elements 22 are arranged in rows and columns in units of pixels.

Since a high voltage is applied to the phosphor screen 16, the plate glass as the material of the front and rear substrates 11 and 12 and support members 14 is high-distortion-point glass. As shown in FIGS. 2 and 4, the frame 13 is formed of a plurality of, e.g., two frame members 13a and 13b. The frame members 13a and 13b are substantially L-shaped, and have their ends outwardly angled by about 45° with respect to the linear portions thereof. The frame members 13a and 13b are formed of a metal bar or wire having a circular section, and have their surfaces coated with a silver plate layer 15. The frame member 13a has its ends abutting on the ends of the other frame member 13b. The frame members 13a and 13b provide the rectangular frame 13. The ends of the frame members 13a and 13b are overlapped each other in a direction parallel with the surface of the front substrate 11, thereby forming joints 27. The gap between the front substrate 11 and frame 13 and the gap between the rear substrate 12 and frame 13 are sealed with a sealing layer 33 formed by fusing a ground layer 31 provided on the sealing surfaces, and an indium layer 32 formed on and bonded to the ground layer. Further, the abutting ends of the frame members 13a and 13b are bonded by indium.

A method of manufacturing the FED constructed as the above will now be described in detail.

Firstly, the phosphor screen 16 is formed on plate glass serving as the front substrate 11. More specifically, plate glass of the same size as the front substrate 11 is prepared, and a stripe pattern of a phosphor layer is formed on the plate glass using a plotter machine. The plate glass with the phosphor stripe pattern and plate glass for the front substrate are placed on a positioning jig and set on an exposure table, thereby performing exposure and development to produce the phosphor screen 16.

Subsequently, the electron emission elements 22 are formed on plate glass for the rear substrate. Specifically, conductive cathode layers are formed in a matrix on the plate glass, and an insulation film of silicon dioxide is formed on the conductive cathode layers by, for example, thermal oxidation, CVD or sputtering. After that, a metal film for gate electrodes, which is formed of molybdenum or niobium, is formed on the insulation film by, for example, sputtering or electron-beam deposition. Thereafter, a resist of the pattern corresponding to the to-be-formed gate electrodes is formed by lithography. Using the resist pattern as a mask, the metal film is etched into gate electrodes 28 by wet or dry etching.

Subsequently, using the resist pattern and gate electrodes as masks, the insulation film is etched into cavities 25 by wet or dry etching. After removing the resist pattern, electron-beam deposition is performed on the surface of the rear substrate at a preset angle with respect to the surface, thereby forming, on the gate electrodes 28, peel layers formed of, for example, aluminum or nickel. After that, a material, such as molybdenum, for cathodes is vertically deposited on the rear substrate surface by electron-beam deposition. As a result, an electron emission element 22 is formed in each cavity 25. Subsequently, the peel layer and metal film thereon are removed by the liftoff method.

After forming the electron emission elements 22, a plurality of support members 14 are provided on the rear substrate 12. Thereafter, the frame members 13a and 13b providing the frame 13 are formed. The frame members 13a and 13b are each formed by bending a metal bar of a circular section into an L-shape in accordance with the size of the frame 13. The frame members 13a and 13b are formed of, for example, an NiFe alloy having substantially the same thermal expansion coefficient as the glass panel of the front and rear substrates.

After that, the frame members 13a and 13b are plated with silver. Specifically, firstly, a round bar of an NiFe alloy is rinsed using pure water or alcohol, and dried. The round bar is then placed in a plating-liquid vessel and subjected to electrolytic plating, whereby the round bar is plated with a silver film of about 2 to 7 μm. Thereafter, the round bar is rinsed using pure water or alcohol, and dried. As a result, frame members 13a and 13b plated with a silver layer 15 are acquired.

The frame members 13a and 13b have the same size and shape and can be treated as common components. Further, since the frame 13 is formed of two members 13a and 13b, the workability and moldability can be enhanced. The frame members plated with silver exhibit a high affinity to a sealing metal, described later, and can realize sealing of high airtightness.

Subsequently, the sealing surface of the front substrate 11, which is formed of an inner peripheral edge portion thereof, and the sealing surface of the rear substrate 12, which is formed of an inner peripheral edge portion thereof, are coated with silver paste by screen printing, thereby forming a frame-shaped ground layers 31. The ground layer 31 is coated with indium as a conductive sealing metal layer, whereby an indium layer 32 is formed over the entire circumference of the ground layer. It is desirable to use, as the sealing metal, a low-melting-point metal having a low melting-point of about 350° C. or less and excellent in adhesion and bonding.

The first and second frame members 13a and 13b are placed on one of the substrates, e.g., on the indium layer 32 of the front substrate 11. At this time, as shown in FIG. 4, the first and second frame members 13a and 13b are made to abut on each other to thereby form a rectangular frame. At the same time, the first and second frame members 13a and 13b are positioned with respect to the front substrate 11.

After that, as shown in FIG. 5, the rear substrate 12 with the ground layer 31 and indium layer 32 provided on the sealing surfaces is opposed to the front surface 11 with the frame 13 on the indium layer 32, with a preset distance defined therebetween. At this time, for example, the front substrate 1 is directed upward and placed below the rear substrate 12. In this state, the front and rear substrates 11 and 12 are held by, for example, an assembly jig, and placed in a vacuum-processing apparatus.

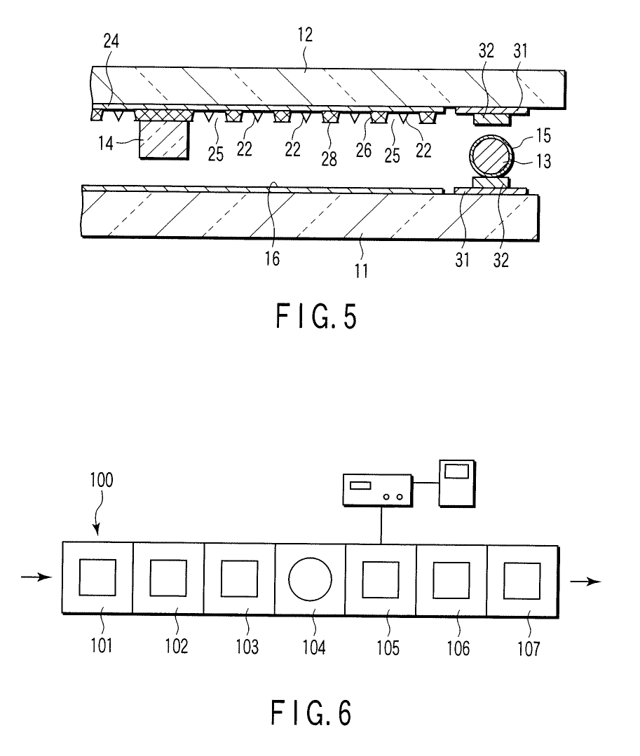

As shown in FIG. 6, a vacuum-processing apparatus 100 comprises a load chamber 101, baking/electron-beam-cleaning chamber 102, cooling chamber 103, getter-film deposition chamber 104, assemblage chamber 105, cooling chamber 106 and unload chamber 107. Each chamber is constructed as a process chamber capable of vacuum processing, and all chambers are maintained in a vacuum state when producing an FED. Further, the adjacent process chambers are connected to each other by, for example, a gate valve.

After the front substrate 11 with the frame 13 and the rear substrate 12 are loaded into the load chamber 101, the load chamber 101 is exhausted. Subsequently, the front and rear substrate 11 and 12 are sent to the baking/electron-beam-cleaning chamber 102. In the baking/electron-beam-cleaning chamber 102, when the degree of vacuum reaches approx. 10⁻⁵ Pa, the rear and front substrates 12 and 11 are heated to approx. 300° C., thereby sufficiently discharging the gas absorbed in the surface of each substrate.

At this temperature, the indium layers (their melting-point is approx. 156° C.) 32 are melted. However, since the indium layers 32 are formed on the ground layers 31 that exhibit a high affinity thereto, indium does not flow and reliably adheres the first and second frame members 13a and 13b to the front substrate 11. Indium spreads to the gaps between the first and second frame members 13a and 13b. Note that since the sealing property may be degraded by the gas discharged from the frame members, it is desirable that the frame members be baked to discharge the gas before indium and the frame members are adhered. However, if the back process is performed at 200° C. or less, such pre-baking is not necessary. The front substrate 11 with the frame 13 adhered thereto will hereinafter be referred to as “the front-substrate-side assembly”.

In the baking/electron-beam-cleaning chamber 102, during heating, an electron-beam generation unit, not shown, applies an electron beam to the phosphor screen of the front-substrate-side assembly and the electron-emission-element surface of the rear substrate 12. Since the electron beam is deflected and scanned by a deflection unit mounted on the external portion of the electron-beam generation unit, it can clean the entire phosphor screen and electron-emission-element surface.

After electron-beam cleaning, the front-substrate-side assembly and rear substrate 12 are sent to the cooling chamber 103, where they are cooled to approx. 100° C. Subsequently, the front-substrate-side assembly and rear substrate 12 are sent to the deposition chamber 104, where a Ba film as a getter film is deposited on the outer surface of the phosphor screen. The Ba film prevents the surface from being contaminated by oxygen or carbon, thereby keeping it in an active state.

After that, the front-substrate-side assembly and rear substrate 12 are sent to the assemblage chamber 105. In this chamber, current is flown to the indium layers 32 and frame members 13a and 13b to heat them, with the front-substrate-side assembly and rear substrate 12 stacked. As a result, the indium layers 32 are again melted into a liquid or softened, whereby the front-substrate-side assembly and rear substrate 12 are attached to each other in a sealed state via the frame 13 to provide the vacuum envelope 10. Conduction heating is performed by, for example, providing electrodes at the joints 27 of the frame 13.

The thus-formed vacuum envelope 10 is cooled down to the room temperature in the cooling chamber 106, and is then unloaded from the unload chamber 107. From the above-described process, the vacuum envelope of the FED is completed.

In the FED constructed as the above and its manufacturing method, the front and rear substrates 11 and 12 are attached to each other in a sealed state in a vacuum, and baking and electron-beam cleaning are performed to sufficiently discharge the gas absorbed in the surface of the substrates. Further, the getter film is also prevented from oxidation to thereby provide a sufficient gas absorption effect. As a result, an FED capable of maintaining a high degree of vacuum can be acquired.

The frame 13 comprises a plurality of, e.g., two, frame members. Compared to a rectangular frame formed of a single member, the frame members can be easily transferred, assembled or handled, and can be prevented from being deformed when they are transferred or assembled. At the same time, the workability or moldability of the frame can be enhanced. Accordingly, a frame of a desired shape can be attached in a sealed manner at a preset location with high accuracy, with the result that a reliable sealed state can be easily provided even for a large display unit of 50 inches or more, and hence high airtightness and mass productivity can be acquired. Further, plating the frame members with silver enhances the affinity of the frame members to the sealing member, thereby realizing highly airtight sealing.

The material of the frame members is not limited to an NiFe alloy. Other materials, which can be subjected to plating and have a thermal expansion coefficient relatively similar to that of the substrates, may be used. For instance, a conductive metal, such as Fe, Ni, Ti or stainless steel, or an alloy of such metals, or a non-conductive material, such as glass or ceramic, may be used. Furthermore, the cross section of the frame members is not limited to a circular one, but may be changed to a rectangular or elliptic one, when necessary. Yet further, the frame members are not limited to solid-core ones, but may be hollow. The plated material is not limited to silver, but may be gold, platinum, palladium or nickel, etc. It is sufficient if the plated material exhibits wettability with respect to the sealing material. If sufficient wettability of the frame members can be acquired, and vacuum sealing can be realized, the sealing material may be directly attached with no plated layer. The sealing material is not limited to indium, but may be an indium alloy or inorganic adhesive. Other materials may be used if they do not degrade the degree of vacuum or sealing.

The frame 13 is not limited to the two-piece one, but may be divided into three or more portions, namely, may be formed of three or more frame members. The frame members are not limited to L-shaped ones, but may have another shape, such as linear or U shape. The ends of the frame members may be obliquely angled or be straight.

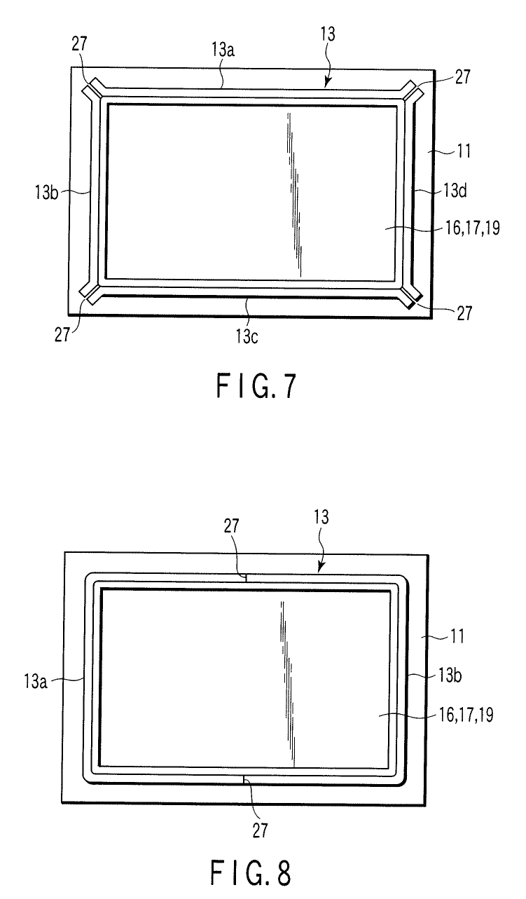

For instance, in a first modification as shown in FIG. 7, the frame 13 comprises four frame members 13a, 13b, 13c and 13d. The frame members 13a, 13b, 13c and 13d are formed linearly, and provide the long and short sides of the frame 13. The opposite ends of each frame member are angled by substantially 45° with respect to the linear portion. At the corners of the frame 13, the ends of the frame members 13a, 13b, 13c and 13d abut on each other in the direction parallel to the surface of the substrate. The joints 27 of the frame members are attached in a sealed state by a sealing material, and the gaps therebetween are filled with the material.

The joints 27 of the frame members may not always be provided at the corners of the frame 13, but may be provided along the sides. In a second modification as shown in FIG. 8, the frame 13 comprises two frame members 13a and 13b that are substantially U-shaped. Along the long sides of the frame 13, the ends of the frame members 13a and 13b abut on each other in the direction parallel to the surface of the substrate. The joints 27 of the frame 13 are attached in a sealed state by a sealing material, and the gaps therebetween are filled with the material.

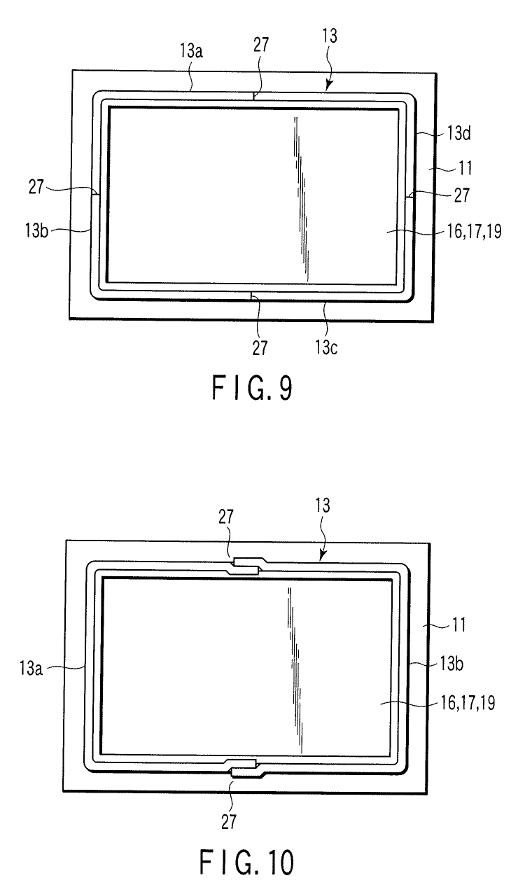

In a third modification as shown in FIG. 9, the frame 13 comprises four frame members 13a, 13b, 13c and 13d that are substantially L-shaped. Along the short and long sides of the frame 13, the ends of the frame members 13a, 13b, 13c and 13d abut on each other in the direction parallel to the surface of the substrate. The joints 27 of the frame 13 are attached in a sealed state by a sealing material, and the gaps therebetween are filled with the material.

As a fourth modification as shown in FIG. 10, the ends of the frame members 13a and 13b may be coupled to each other such that they overlap each other along a preset length in the direction perpendicular to the long sides of the frame and in the direction parallel to the surface of the substrate.

In the first to fourth modifications, the other elements of the FEDs are similar to those of the above-described embodiment. The similar elements are denoted by corresponding reference numbers, and are not described in detail. The first to fourth modifications can also provide the same advantage as the above-mentioned embodiment. In light of the positioning of the frame on the substrate, it is desirable to divide the frame into two portions or so. In contrast, in light of the easiness of transfer or handling of the frame, it is desirable to divide the frame into a large number of portions.

The present invention is not limited to the above-described embodiment and modifications, but may be further modified in various ways without departing from the scope. Various inventions can be realized by appropriately combining the structure elements disclosed in the embodiment and modifications. For instance, some of the disclosed structural elements may be deleted. Some structural elements included in the embodiment and modifications may be combined appropriately.

For instance, although in the embodiment, the electron emission elements are of a field emission type, they are not limited thereto, but may be other types of electron emission elements, such as pn-type cold cathode elements or electron emission elements of a surface conduction type. Further, the invention is also applicable to the manufacture of other image display apparatuses, such as plasma display panels or electroluminescence (EL) display panels.

What is claimed is:

1. An image display apparatus comprising:
a front substrate and a rear substrate opposing each other with a gap defined therebetween; and
a frame arranged between peripheral edges of the front and rear substrates and attached in a sealed state to the front and rear substrates by a sealing material,
the frame being formed by bonding a plurality of frame members, and includes at least two joints.

2. The image display apparatus according to claim 1, wherein the frame members each include a pair of ends, each of the ends of one of the frame members being bonded to a corresponding one of the ends of the other frame member, said each of the ends overlapping the corresponding one of the ends in a direction parallel to a surface of the front substrate.

3. The image display apparatus according to claim 1, wherein the frame includes four linear frame members that form sides of the frame.

4. The image display apparatus according to claim 1, wherein the frame includes two L-shaped frame members, ends of the two frame members being bonded to each other and forming corners of the frame.

5. The image display apparatus according to claim 1, wherein the frame includes two substantially U-shaped frame members, ends of the two frame members being bonded to each other and located at opposing sides of the frame.

6. The image display apparatus according to claim 1, wherein the frame includes four L-shaped frame members, ends of the four frame members being bonded to each other and located at sides of the frame.

7. The image display apparatus according to claim 1, wherein a sealing material seals the gap between the front and rear substrates, and attaches ends of the frame members to each other in a sealed state.

8. The image display apparatus according to claim 1, wherein the frame members are formed of a metal.

9. The image display apparatus according to claim 8, wherein the frame members are formed of a metal having substantially a same thermal expansion coefficient as a thermal expansion coefficient of the front and rear substrates.

10. The image display apparatus according to claim 8, wherein surfaces of the frame members are plated with a metal having a high wettability with respect to the sealing material.

11. The image display apparatus according to claim 8, wherein the frame members are formed of glass.

12. The image display apparatus according to claim 1, wherein the sealing material is a low-melting-point metal.

13. The image display apparatus according to claim 1, wherein the sealing material has conductivity.

14. The image display apparatus according to claim 1, further comprising a phosphor layer provided on an inner surface of the front substrate, and a plurality of electron sources provided on an inner surface of the rear substrate for exciting the phosphor layer.
